(19) United States
(12) Patent Application Publication
(10) Pub. No.: US 2024/0385730 A1
(43) Pub. Date: Nov. 21, 2024

(54) METHOD FOR CONTROLLING MULTI-WINDOW SCREEN AND ELECTRONIC DEVICE FOR SUPPORTING SAME

(71) Applicant: SAMSUNG ELECTRONICS CO., LTD., Suwon-si (KR)

(72) Inventor: Seungdoo CHOI, Suwon-si (KR)

(21) Appl. No.: 18/786,183

(22) Filed: Jul. 26, 2024

Related U.S. Application Data
(63) Continuation of application No. PCT/KR2022/018780, filed on Nov. 25, 2022.

(30) Foreign Application Priority Data
Jan. 27, 2022 (KR) 10-2022-0012197
Apr. 1, 2022 (KR) 10-2022-0041365

(51) Int. Cl. G06F 3/0482; G06F 3/0484

(52) U.S. Cl. CPC G06F 3/0482; G06F 3/0484; G06F 2203/04803

(57) ABSTRACT

Disclosed are a method for controlling a multi-window screen and an electronic device for supporting same. The electronic device comprises a display, at least one processor, and memory storing instructions. The instructions, when executed by the at least one processor, cause the electronic device to identify at least one window in which multimedia content is executed, while displaying a divided screen comprising a plurality of windows on a display. The instructions, when executed by the at least one processor, cause the electronic device to display a menu item comprising a first object for lock setting, in response to receiving a first user input on one side of the divided screen. The instructions, when executed by the at least one processor, cause the electronic device to lock at least one window and display the at least one window that is locked, when receiving a second user input for the first object.

### CROSS-REFERENCE TO RELATED APPLICATIONS

This application is a continuation application, claiming priority under § 365(c), of International Application No. PCT/KR2022/018780, filed on Nov. 25, 2022, which is based on and claims the benefit of Korean patent application number 10-2022-0041365 filed on Apr. 1, 2022, in the Korean Intellectual Property Office and of Korean patent application number 10-2022-0012197, filed on Jan. 27, 2022, in the Korean Intellectual Property Office, the disclosures of which are incorporated by reference herein in their entireties.

### TECHNICAL FIELD

Various embodiments disclosed in the present document relate to a method and device for controlling a multi-window screen in an electronic device.

### BACKGROUND ART

With the development of mobile communication technologies, the use of mobile electronic devices that enable communication and information processing during movement, such as smartphones or tablet PCs, has become common, and services or functions provided through these electronic devices are becoming increasingly diverse. For example, the electronic devices can provide users with various useful functions, such as a call function, which is a unique function, as well as a message sending and receiving function, a shooting function, a broadcast playback function, a video playback function, a music playback function, an Internet function, or a social networking service (SNS) function. Recently released electronic devices can support a multi-tasking function of providing two or more services simultaneously, and this can be provided in a multi-window form of displaying application execution screens corresponding to a plurality of services in a plurality of divided regions within a display.

### DISCLOSURE OF INVENTION

### Technical Problem

When using a multi-window function in an electronic device, a user can perform other tasks, such as sending and receiving messages, searching, or additionally executing other multimedia content, in a state of executing multimedia content. In a process of performing several tasks simultaneously, when the user accidentally touches a multimedia content execution screen while performing other tasks (e.g., writing a message or searching the Internet), a situation can occur where handling not intended by a user is executed on the multimedia content execution screen or the multimedia content execution screen is ended. Owing to this, the user can feel uncomfortable.

### Solution to Problem

In various embodiments of the present document, when a multi-window function is used in an electronic device, a user interface capable of at least temporarily locking a multimedia content execution screen can be provided, thereby improving the usability of a multi-window function and enhancing a user convenience.

Technical tasks to be achieved in embodiments disclosed in the present document are not limited to the technical tasks mentioned above, and other technical tasks not mentioned would be understood by those skilled in the art from the description below.

An electronic device of an embodiment disclosed in the present document may include a display, at least one processor, and memory storing instructions. The instructions, when executed by the at least one processor, may cause the electronic device to, while displaying a divided screen including a plurality of windows on the display, identify at least one window in which multimedia content is executed. The instructions, when executed by the at least one processor, may cause the electronic device to display a menu item including a first object for lock setting, in response to receiving a first user input on one side of the divided screen. The instructions, when executed by the at least one processor, may cause the electronic device to, when receiving a second user input for the first object, lock the at least one window and display the at least one window that is locked.

A method of operating an electronic device of an embodiment disclosed in the present document may comprise, while displaying a divided screen including a plurality of windows on a display, identifying at least one window in which multimedia content is executed. The method may comprise, displaying a menu item including a first object for lock setting in response to receiving a first user input on at least one side of the divided screen. The method may comprise, when receiving a second user input for the first object, locking the at least one window and displaying the at least one window that is locked.

### Advantageous Effects of Invention

According to various embodiments disclosed in the present document, an electronic device may provide a function capable of locking a multimedia content execution screen during multi-window operation, thereby preventing the processing of handling not intended by a user and improving the usability of a multi-window function. Also, according to various embodiments disclosed in the present document, other tasks may be processed simultaneously while multimedia content is watched, and thus an improved user experience and convenience may be provided.

In addition, various effects that may be directly or indirectly identified through the present document may be provided.

### BRIEF DESCRIPTION OF DRAWINGS

FIG. 1 a block diagram of an electronic device in a network environment according to an embodiment.

FIG. 2 is a diagram explaining a construction of an electronic device according to an embodiment.

FIGS. 3A, 3B, and 3C are diagrams explaining a method of providing a menu item when executing a multi-window according to an embodiment.

FIGS. 4A and 4B are diagrams explaining a method of providing a menu item when there is no window in which multimedia content is executed on a multi-window screen, according to an embodiment.

FIGS. 5A, 5B, and 5C are diagrams explaining a method of lock setting when there is only one window in which multimedia content is executed on a multi-window screen, according to an embodiment.

FIGS. 6A, 6B, 6C, 6D, 6E, 6F, and 6G are diagrams explaining a method of sequentially lock setting when there are two or more windows in which multimedia content is executed on a multi-window screen, according to an embodiment.

FIGS. 7A, 7B, 7C, and 7D are diagrams explaining a method of lock setting based on a direction of a gesture input when there are two or more windows in which multimedia content is executed on a multi-window screen, according to an embodiment.

FIGS. 8A and 8B are diagrams explaining a method of simultaneously lock setting when there are two or more windows in which multimedia content is executed on a multi-window screen, according to an embodiment.

FIGS. 9A, 9B, and 9C are diagrams explaining a method of displaying a lock set window, according to an embodiment.

FIG. 10 is a flowchart illustrating a method of operating an electronic device, according to an embodiment.

FIGS. 11A, 11B, 11C, and 11D are diagrams explaining a method of locking and unlocking a window in which multimedia content is executed on a multi-window screen, according to an embodiment.

FIGS. 12A and 12B are diagrams explaining a method of locking and unlocking a window in which multimedia content is executed through a menu item on a multi-window screen, according to an embodiment.

In relation to the description of the drawings, the same or like reference numerals may be used for the same or like components.

### DETAILED DESCRIPTION: MODE FOR CARRYING OUT THE INVENTION

Various embodiments disclosed in the present document will be described below with reference to the attached drawings. This is not intended to limit the various embodiments of the present disclosure to a specific form, and should be understood as including various modifications, equivalents, and/or alternatives of the present disclosure.

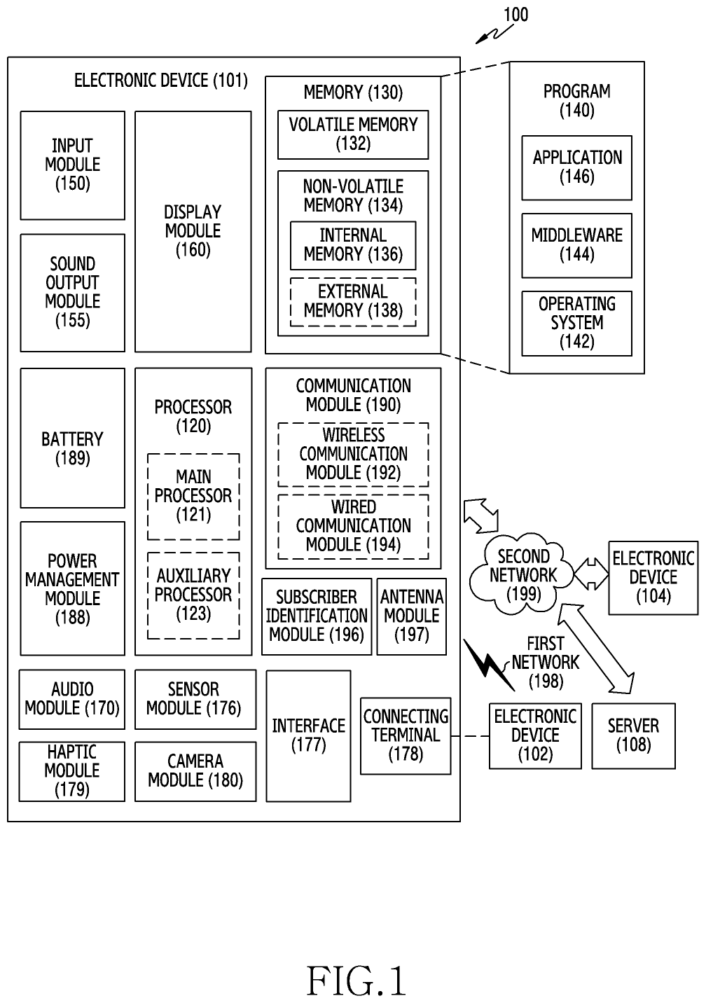

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

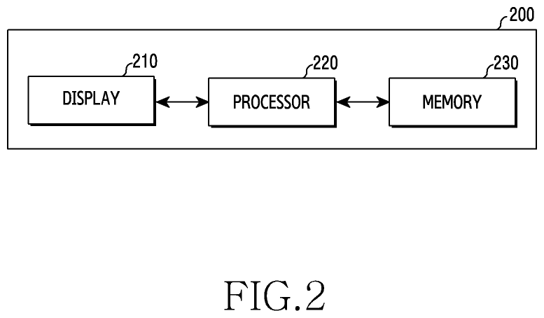

FIG. 2 is a diagram explaining a construction of an electronic device 200 according to an embodiment.

Referring to FIG. 2, the electronic device 200 is a device providing a lock set function for a screen in which multimedia content is being executed in a multi-window environment, and may include a display 210, at least one processor 220, and/or a memory 230. In FIG. 2, the electronic device 200 may correspond to the electronic device 101 shown in FIG. 1.

In an embodiment, the display 210 (e.g., the display module 160 of FIG. 1) may display a screen corresponding to one or more applications (or programs) executed by a user. For example, when two or more applications are executed simultaneously, the display 210 may divide the screen within the display 210 into a plurality of regions, and display windows corresponding to execution screens of the two or more applications in the respective divided regions.

In an embodiment, the display 210 may be comprised of at least one of a liquid crystal display (LCD), a thin film transistor LCD (TFT-LCD), an organic light emitting diode (OLED), a light emitting diode (LED), an active matrix organic LED (AMOLED), a flexible display, and a 3-dimensional display. Also, some of these displays may be comprised of a transparent type or light-transmissive type so that the outside may be viewed through them. This may be constructed in a transparent display form including a transparent OLED (TOLED).

In an embodiment, the memory 230 (e.g., the memory 130 of FIG. 1) may store instructions of controlling at least one processor 220 (e.g., the processor 120 of FIG. 1) to perform various operations when executed. For example, while displaying a divided screen including a plurality of windows on the display 210, the at least one processor 220 may identify at least one window in which multimedia content is executed. The multimedia content may include at least one of music, video, game, or streaming service. According to various embodiments, when a program or data loaded at the time of providing multimedia content is detected, the at least one processor 220 may identify that multimedia content is executed.

In an embodiment, the at least one processor 220 may detect a user input on at least one side of the screen while displaying the screen, and may provide a menu item for screen handling in response to the user input. According to various embodiments, the menu item may include a first object for lock setting the at least one window. For example, when a user's touch input is detected through a boundary region between the plurality of windows displayed through the screen or a display region of the at least one window in which multimedia content is executed, the at least one processor 220 may display a menu item including the first object on the display 210. The first object may be provided using a user interface element such as an icon or button indicating a locking function.

In an embodiment, when detecting a gesture input on the first object, the at least one processor 220 may identify that the first object is selected, and lock the at least one window. For example, the at least one processor 220 may lock set the at least one window, based on a touch input on the first object. For another example, the at least one processor 220 may lock set the at least one window, based on a drag input generated with a criterion of the first object. While the at least one window is lock set, the at least one processor 220 may allow the at least one window to operate while maintaining the existing setting, and may process not to perform a detected user input or handling command for the at least one window. While the at least one window is lock set, the at least one processor 220 may process to provide a service or operation corresponding to a user input or handling command for the remaining windows excluding the at least one window.

In an embodiment, the at least one processor 220 may lock two or more windows in which multimedia content is executed among a plurality of windows displayed through the screen. For example, the at least one processor 220 may lock all the two or more windows while sequentially activating the two or more windows. The at least one processor 220 may identify that a window corresponding to a region most recently touched by a user is in an activation state. In this case, when identifying a selection of the first object based on a touch input while the first window is in the activation state, the at least one processor 220 may lock set the first window. Thereafter, the at least one processor 220 may identify that the second window, which is different from the first window, is converted to the activation state, and display the menu item, based on a user input detected within the screen. When identifying that the first object is selected through the menu item while the second window is in the activation state, the at least one processor 220 may set (or proceed) to additionally lock the second window. For another example, the at least one processor 220 may lock the two or more windows, based on a direction of a drag input detected on the first object. When detecting that the drag input is generated toward a region where the first window is disposed, the at least one processor 220 may lock set the first window. Thereafter, when detecting a drag input toward a region where the second window is disposed while the first window is lock set, the at least one processor 220 may set to additionally lock the second window.

According to various embodiments, the at least one processor 220 may provide a function capable of simultaneously locking the two or more windows. For example, when identifying two or more windows in which multimedia content is executed while providing a plurality of windows through the screen, the at least one processor 220 may additionally provide a second object for simultaneous lock setting through the menu item, in response to a user input detected on at least one side of the screen. When detecting a gesture input on the second object, the at least one processor 220 may set to lock all the two or more windows.

In an embodiment, the at least one processor 220 may display locked at least one window in various methods. For example, the at least one processor 220 may display an icon indicating a locked state on one side of the locked at least one window. The at least one processor 220 may apply a specified level of brightness or shading to the icon and display the locked state, or apply an animation effect to the icon and display the locked state. For another example, the at least one processor 220 may display a border of a specified thickness in a circumferential region of the locked at least one window. The at least one processor 220 may display the border in a specified color, or apply a flickering effect to the border at a specified cycle and display a lock set state. For further example, the at least one processor 220 may display a locked state by using an indicator included in the at least one window. The indicator may be a user interface that displays a state corresponding to activation or deactivation of each window. The at least one processor 220 may apply at least one of a color, pattern, or effect corresponding to the locked state to the indicator and display the lock state.

In an embodiment, when detecting a selection of the first object while the at least one window is lock set, the at least one processor 220 may unlock the at least one lock set window. For example, when the at least one processor 220 detects a user input from at least one side of the screen while the first window is in a lock set state, the at least one processor 220 may provide a menu item including the first object, and unlock the first window that is in the lock set state when the first object is selected through the menu item. For another example, when two or more windows are lock set, the at least one processor 220 may unlock the two or more windows by using the first object while sequentially activating the two or more windows, or unlock the two or more windows, based on a direction of a gesture input on the first object. According to various embodiments, when the second object is additionally provided through the menu item, the at least one processor 220 may unlock all the two or more windows simultaneously, when the at least one processor 220 detects a gesture input on the second object while the two or more windows are in a lock set state. Like this, the at least one processor 220 may provide a function capable of at least temporarily locking a window in which multimedia content is executed while the electronic device 200 provides a multi-window screen, thereby preventing the window in which the multimedia content is executed from being handled or ended regardless of a user's intention, and providing a user convenience.

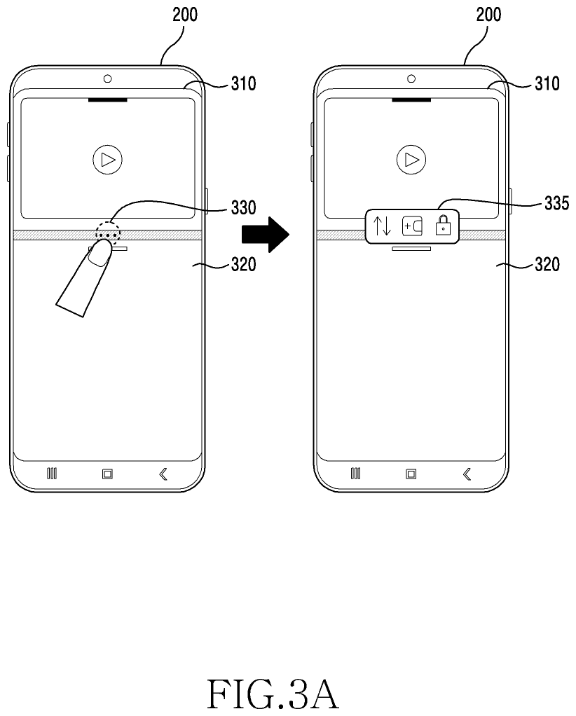

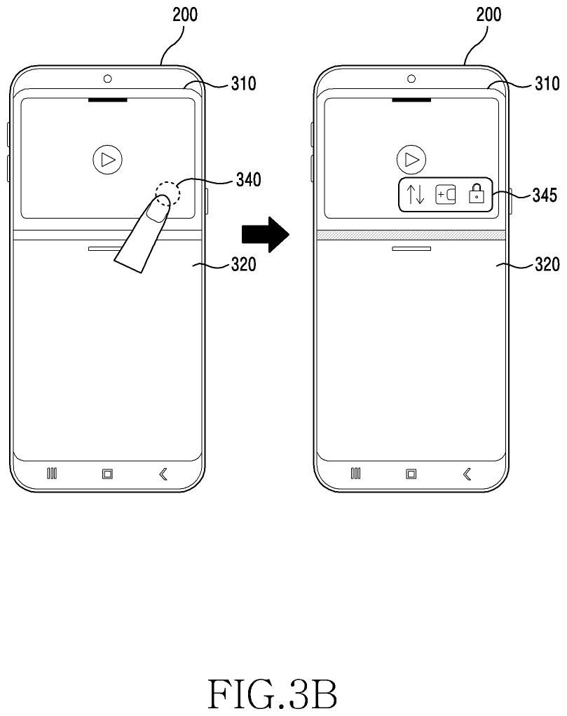

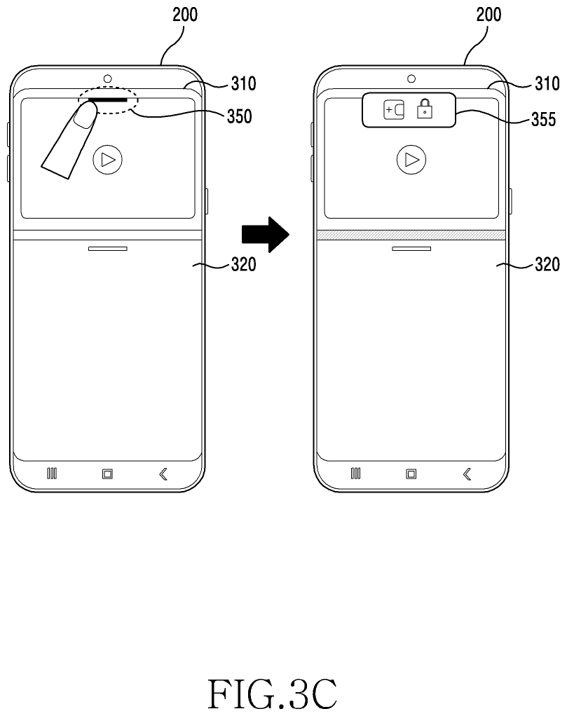

FIGS. 3A, 3B, and 3C are diagrams explaining a method of providing a menu item when executing a multi-window according to an embodiment. According to various embodiments, when a plurality of applications (or programs) are executed, the electronic device 200 may divide a screen within a display (e.g., the display module 160 of FIG. 1 or the display 210 of FIG. 2) into a plurality of regions, and provide a window in which the application (or program) is executed, through each region of the divided screen. The electronic device 200 may provide menu items 335, 345, and 355 for screen handling in various methods while providing the divided screen.

Referring to FIG. 3A, the electronic device 200 may display a first window 310 in an upper region of the divided screen, and display a second window 320 in a lower region of the divided screen. The electronic device 200 may output a handler 330 for menu call in a boundary region between the first window 310 and the second window 320 while providing the divided screen.

In an embodiment, when detecting a touch input on the handler 330 of the boundary region, the electronic device 200 may output a menu item 335 for multi-window screen handling in the boundary region. The electronic device 200 may provide various functions for handling the screen through the menu item 335. For example, a position switching function of changing positions of the first window 310 and the second window 320 arranged within the screen and/or an app pairing function capable of bundling and registering running applications to a border panel and executing as a multi-window at any time may be included. According to various embodiments, the electronic device 200 may additionally provide a function for, when there is a window in which multimedia content is executed among windows included in the divided screen, at least temporarily lock setting the window in which the multimedia content is executed. The multimedia content may include at least one of music, video, game, or streaming service. For example, the electronic device 200 may provide a function for lock setting the first window 310 through the menu item 335, when identifying that multimedia content is executed in the first window 310 while providing the first window 310 and the second window 320 through the divided screen. Functions included in the menu item 335 may be provided using user interface elements such as icons or buttons corresponding to the respective functions.

In an embodiment, the electronic device 200 may provide a menu item 345 for multi-window screen handling, based on a touch input detected in a region corresponding to each window. For example, as shown in FIG. 3B, when detecting a touch input on one side 340 of a display region of the first window 310, the electronic device 200 may display the menu item 345 including various functions for handling the divided screen. The menu item 345 may be displayed with a criterion of a position where the touch input is detected within the first window 310. The electronic device 200 may identify that multimedia content is executed in the first window 310, and display the menu item 345 including a lock set function.

For another example, the electronic device 200 may provide a menu item 355, based on a touch input detected on a specified element within a display region of the first window 310. Referring to FIG. 3C, when detecting a touch input on an indicator 350 disposed on an upper side of the first window 310, the electronic device 200 may overlap the menu item 355 including various functions for handling the divided screen on the indicator 350 and display the overlapped menu item 355. The indicator 350 may be a user interface that displays a state corresponding to activation or deactivation of each window. The electronic device 200 may identify that multimedia content is being executed in the first window 310, and display the menu item 355 including a lock set function.

According to various embodiments, the electronic device 200 may provide a different menu item, in response to a touch input detected in a display region of the second window 320. In this case, the electronic device 200 may identify that there is no multimedia content (or content to be locked) that is being executed in the second window 320, and display a menu item excluding the lock set function.

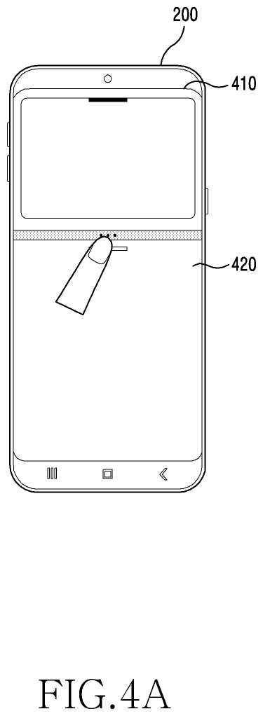

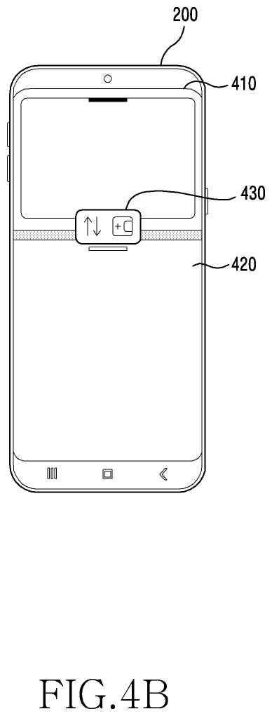

FIGS. 4A and 4B are diagrams explaining a method of providing a menu item when there is no window in which multimedia content is executed on a multi-window screen, according to an embodiment.

Referring to FIG. 4A, the electronic device 200 may display a first window 410 and a second window 420 corresponding to two applications (or programs) running through a divided screen within a display (e.g., the display module 160 of FIG. 1 or the display 210 of FIG. 2).

In an embodiment, as shown in FIG. 4B, when detecting a user input (e.g., a touch input) on at least one side of the divided screen, the electronic device 200 may display a menu item 430 for handling the screen. For example, the electronic device 200 may provide the menu item 430, based on a touch input detected in a boundary region between the first window 410 and the second window 420 within the divided screen. For another example, the electronic device 200 may provide the menu item 430, based on a touch input detected in a display region of the first window 410 or the second window 420. The menu item 430 may be output with a criterion of a position where the touch input is detected within the divided screen.

In FIG. 4B, the electronic device 200 may check whether multimedia content, or content requiring lock setting, is executed in the first window 410 and/or the second window 420. As the checking result, the electronic device 200 may identify that there is no window in which the multimedia content (or the content requiring the lock setting) is executed, and provide the menu item 430 not including a lock set function.

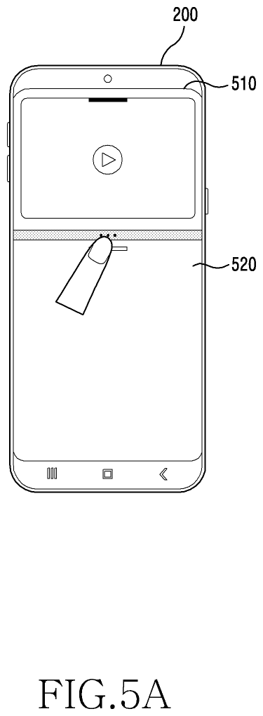

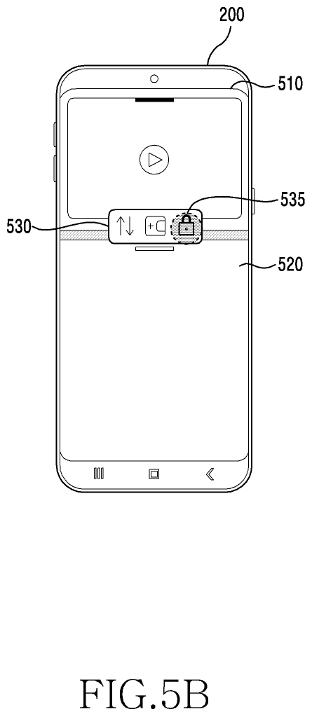

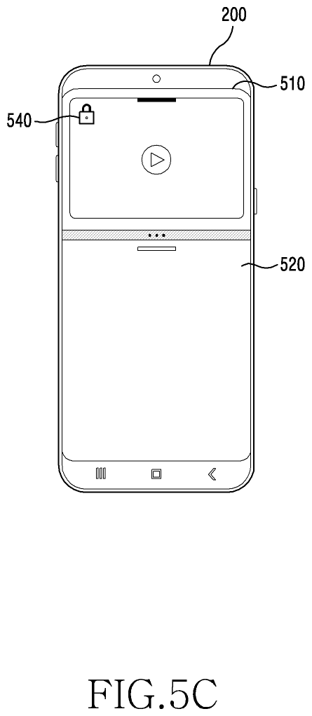

FIGS. 5A, 5B, and 5C are diagrams explaining a method of lock setting when there is only one window in which multimedia content is executed on a multi-window screen, according to an embodiment.

Referring to FIG. 5A, while displaying a divided screen including a first window 510 and a second window 520, the electronic device 200 may detect a user input (e.g., a touch input) on one side of the screen. The first window 510 and the second window 520 may correspond to running applications (or programs), and may be displayed in divided regions of the screen, respectively.

In an embodiment, when detecting a touch input on one side of the screen, the electronic device 200 may display a menu item 530 including functions for handling the screen. In FIG. 5B, the electronic device 200 may detect that a touch input is generated in a boundary region between the first window 510 and the second window 520 within the screen, and display the menu item 530 in the boundary region. At this time, the electronic device 200 may identify that multimedia content, or content requiring lock setting, is executed in the first window 510 among windows displayed through the screen, and construct the menu item 530 to include a lock set function 535 capable of at least temporarily lock setting the first window 510. The lock set function 535 may be displayed using a user interface element such as an icon or button of a key shape indicating locking (e.g., a lock).

According to various embodiments, the electronic device 200 may detect the touch input in a display region of each window displayed through the screen. For example, the electronic device 200 may use the touch input occurring on one side of a display region of the first window 510 or on an element included in the first window 510 (e.g., an indicator indicating an activation state of the corresponding window). In this case, the electronic device 200 may identify that multimedia content, or content requiring lock setting, is executed in the first window 510, and provide the menu item 530 including the lock set function 535. The menu item 530 may be displayed with a criterion of a position where the touch input is detected within the screen. For another example, the electronic device 200 may detect the touch input occurring on one side of a display region of the second window 520 or on an element included in the second window 520 (e.g., an indicator indicating a deactivation state of the corresponding window). In this case, the electronic device 200 may identify that there is no multimedia content (or content requiring a lock setting) executed in the second window 520, and provide the menu item 530 not including the lock set function 535.

In an embodiment, when identifying that the lock set function 535 is selected among the functions displayed through the menu item 530, the electronic device 200 may lock set the first window 510 as shown in FIG. 5C. In FIG. 5C, the electronic device 200 may display an icon 540 indicating a lock set state on one side (e.g., a corner portion of one side, or an upper or lower central portion) of the display region of the first window 510. The electronic device 200 may apply a specified level of brightness or shading to the icon 540 or apply an animation effect such as a sparkling effect to the icon 540 and display the lock set state. The electronic device 200 may also display a text, such as ‘lock setting’ or ‘LOCKED’, instead of the icon 540 or together with the icon 540. In addition to the method shown in FIG. 5C, the electronic device 200 may display that the first window 510 is in a lock set state in various methods. For example, the electronic device 200 may display a border of a specified thickness in a circumferential region of the lock set first window 510. The electronic device 200 may display the border in a specified color, or apply a flickering effect to the border at a specified cycle and display that the first window 510 is in the lock set state. For another example, the electronic device 200 may display a locked state by using an element included in the first window 510 (e.g., an indicator indicating an activation state of the corresponding window). The electronic device 200 may apply at least one of a color, pattern, or effect indicating the locked state to the element and display the locked state.

In an embodiment, the electronic device 200 may unlock the first window 510 in the same method as lock setting the first window 510. For example, when the electronic device 200 detects a user input (e.g., a touch input) on one side of the screen while the first window 510 is lock set, the electronic device 200 may provide the menu item 530 including the lock set function 535. When the electronic device 200 detects that the lock set function 535 is selected while the first window 510 is lock set, the electronic device 200 may process to unlock the lock set first window 510. When the first window 510 is unlocked, the electronic device 200 may remove the icon 540 indicating the locked state shown in FIG. 5C, and display the first window 510 in the same method as the non-locked second window 520.

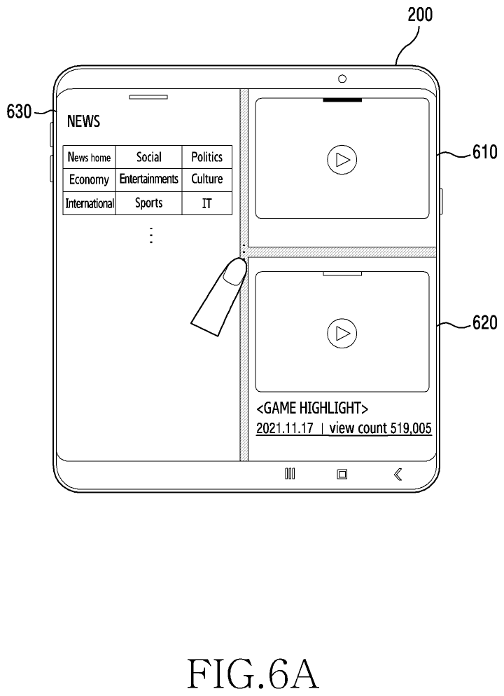

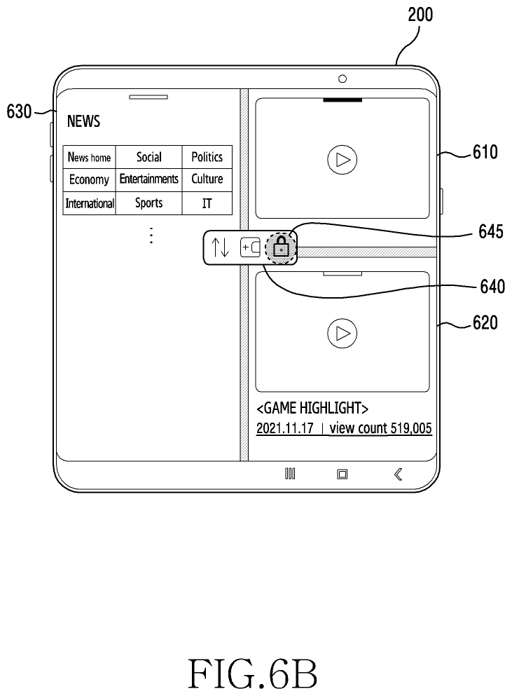

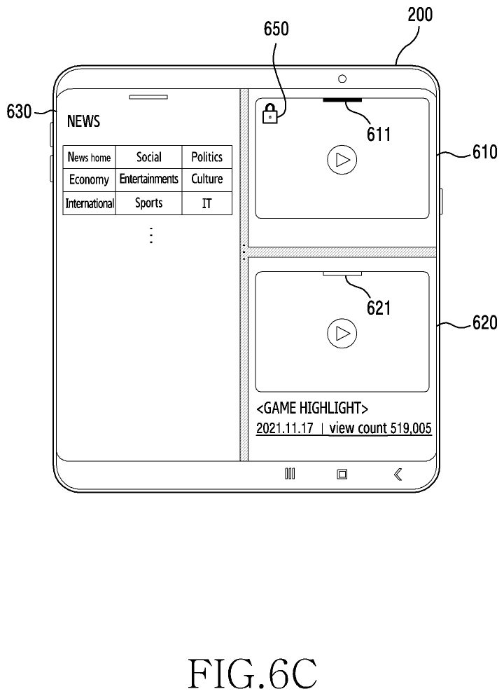

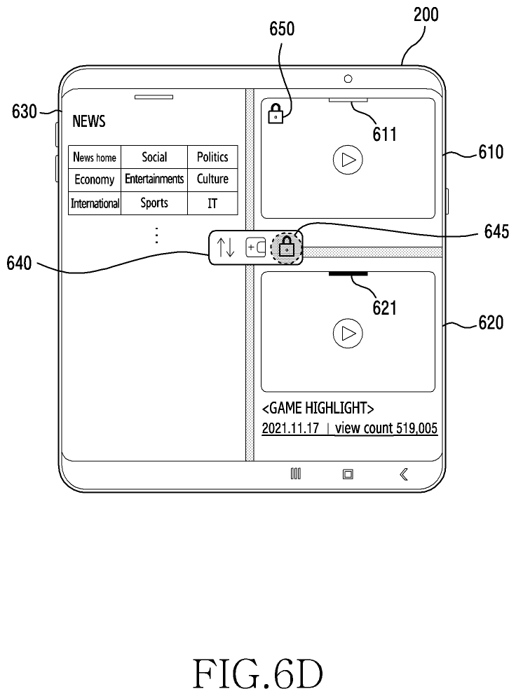

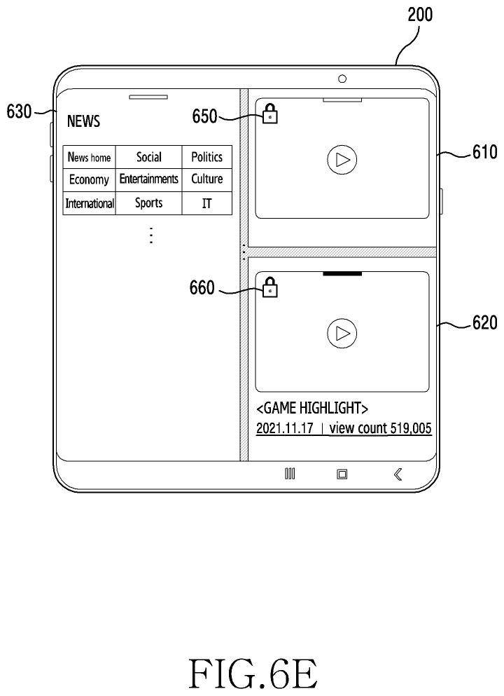

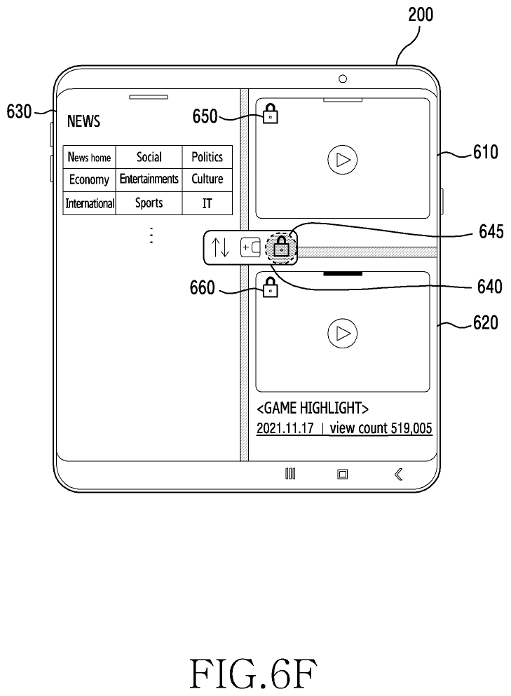

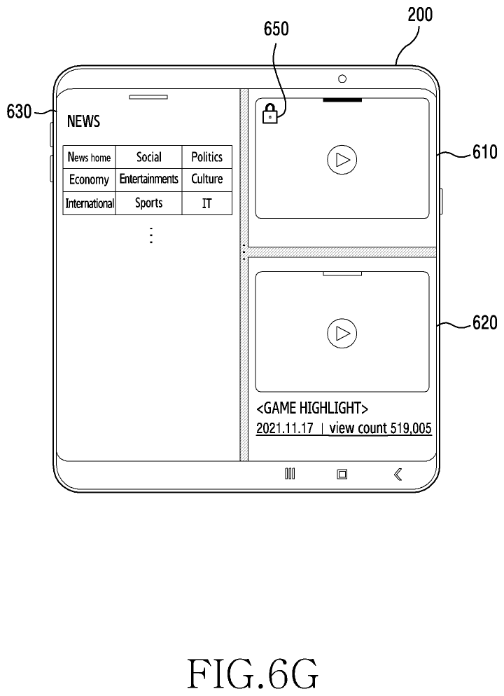

FIGS. 6A, 6B, 6C, 6D, 6E, 6F, and 6G illustrate a method of sequentially lock setting when there are two or more windows in which multimedia content is executed on a multi-window screen, according to an embodiment. According to various embodiments, the electronic device 200 may be a terminal of a flexible type (e.g., a foldable type, a rollable type, or a slideable type) in which a physical form of a display (e.g., the display module 160 of FIG. 1 or the display 210 of FIG. 2) is changeable. When the display of the electronic device 200 is expanded, the electronic device 200 may provide three or more windows by additionally dividing a screen within the display.

Referring to FIG. 6A, while displaying a divided screen including a first window 610, a second window 620, and a third window 630, the electronic device 200 may detect a user input (e.g., a touch input) on one side of the screen. The first window 610, the second window 620, and the third window 630 may correspond to running applications (or programs), and may be displayed in divided regions of the screen, respectively. For example, the first window 610 and the second window 620 may be execution screens of multimedia content (e.g., music, video, game, or streaming service), and the third window 630 may be a web browser execution screen.

In an embodiment, in response to detecting the touch input on one side of the screen, the electronic device 200 may display a menu item 640 including functions for handling the screen. In FIG. 6B, the electronic device 200 may detect that a touch input is generated in a boundary region between the windows 610, 620, and 630 within the screen, and display the menu item 640 in the boundary region. The electronic device 200 may identify that multimedia content, or content requiring lock setting, is executed in the first window 610 and the second window 620 among windows displayed through the screen, and construct the menu item 640 to include a lock set function 645. The lock set function 645 may be displayed using a user interface element such as an icon or button of a key shape indicating locking.

According to various embodiments, the electronic device 200 may detect the touch input occurring in a display region of each window displayed through the screen. For example, the electronic device 200 may detect the touch input on one side of a display region of the first window 610 or the second window 620 or an element included in each of these windows 610 and 620 (e.g., an indicator indicating a state corresponding to activation or deactivation of the corresponding window). In this case, the electronic device 200 may identify that multimedia content, or content requiring lock setting, is executed in the first window 610 and/or the second window 620, and may provide the menu item 640 including the lock set function 645. The menu item 640 may be displayed with a criterion of a position where the touch input is detected within the screen. For another example, the electronic device 200 may detect the touch input occurring on one side of a display region of the third window 630 or on an element included in the third window 630 (e.g., an indicator indicating a deactivation state of the corresponding window). In this case, the electronic device 200 may identify that there is no multimedia content (or content requiring a lock setting) that is being executed in the third window 630, and may provide the menu item 640 not including the lock set function 645.

In an embodiment, when identifying that the lock set function 645 is selected among the functions displayed through the menu item 640, the electronic device 200 may lock set a currently activated window. The electronic device 200 may identify that a window corresponding to a region most recently touched by a user is in an activation state, and may indicate whether each window is activated or deactivated through an indicator 611 or 621 included in each window. For example, the activation state or deactivation state of each window may be distinguished by a color of the indicator 611 or 621. Referring to FIG. 6C, the electronic device 200 may identify that the first window 610 is in the activation state, and lock set the first window 610. The electronic device 200 may display an icon 650 indicating a lock set state on one side (e.g., a corner portion of one side, or an upper or lower central portion) of a display region of the lock set first window 610. The electronic device 200 may also display a text, such as ‘lock setting’ or ‘LOCKED’, instead of the icon 650 or together with the icon 650. The electronic device 200 may apply a specified level of brightness or shading to the icon 650 or the text or apply an animation effect such as a sparkling effect to the icon 650 or the text and display the icon 650 or the text. According to various embodiments, the electronic device 200 may display a window of a lock set state differently from the method shown in FIG. 6C. For example, the electronic device 200 may display a border of a specified thickness in a circumferential region of the lock set first window 610. The electronic device 200 may display the border in a specified color, or apply a flickering effect to the border at a specified cycle and display that the first window 610 is in a lock set state. For another example, the electronic device 200 may also apply at least one of a color, pattern, or effect indicating a locked state to the indicator 611 included in the first window 610 and display the locked state.

In an embodiment, the electronic device 200 may identify that the activated window is changed. For example, in FIG. 6D, the electronic device 200 may identify that the first window 610 changes from an activation state to a deactivation state, and the second window 620 changes from the deactivation state to the activation state. Referring to FIG. 6D, when the electronic device 200 detects a user input (e.g., a touch input) on one side of the screen while the second window 620 is in the activation state, the electronic device 200 may display a menu item 640 including a lock set function 645. The menu item 640 may be provided in the same method as described in FIG. 6B.

In an embodiment, the electronic device 200 may identify that the lock set function 645 is selected through the menu item 640, and additionally lock set the currently activated second window 620. In FIG. 6E, the electronic device 200 may display an icon 660 indicating a lock set state and/or a text such as ‘lock setting’ and ‘LOCKED’ on one side (e.g., a corner portion of one side, or an upper or lower central portion) of a display region of the lock set second window 620. The lock setting of the second window 620 may be displayed in the same method as described in FIG. 6C. When the activated window is not changed and the lock set function 645 is additionally selected while the first window 610 is maintained in the activation state in FIG. 6D, the electronic device 200 may process to unlock the lock set first window 610 without additionally lock setting the second window 620. Like this, when the electronic device 200 intends to lock set two or more windows in which multimedia content is executed, the electronic device 200 may lock set while sequentially activating the windows to be locked. While the first window 610 and the second window 620 are lock set, the electronic device 200 may process to provide a service or operation corresponding to a user input or handling command for the non-locked third window 630.

In an embodiment, the electronic device 200 may unlock the first window 610 and the second window 620 in the same method as lock setting. Referring to FIG. 6F, when detecting a user input (e.g., a touch input) on one side of the screen while the first window 610 and the second window 620 are lock set, the electronic device 200 may display a menu item 640 including a lock set function 645. The electronic device 200 may identify that the lock set function 645 is selected through the menu item 640, and unlock the currently activated second window 620. When the second window 620 is unlocked, the electronic device 200 may remove the icon 660 indicating the locked state of the second window 620 as shown in FIG. 6G, and display the second window 620 in the same method as the non-locked third window 630. Thereafter, when the activated window is changed to the first window 610, the electronic device 200 may unlock the first window 610 in the same method.

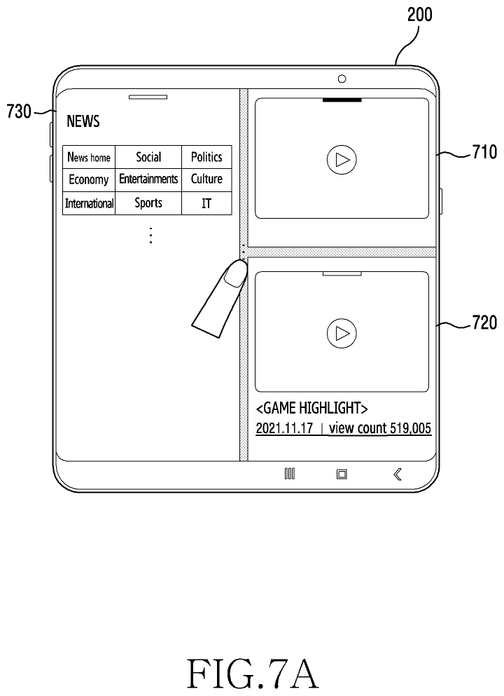

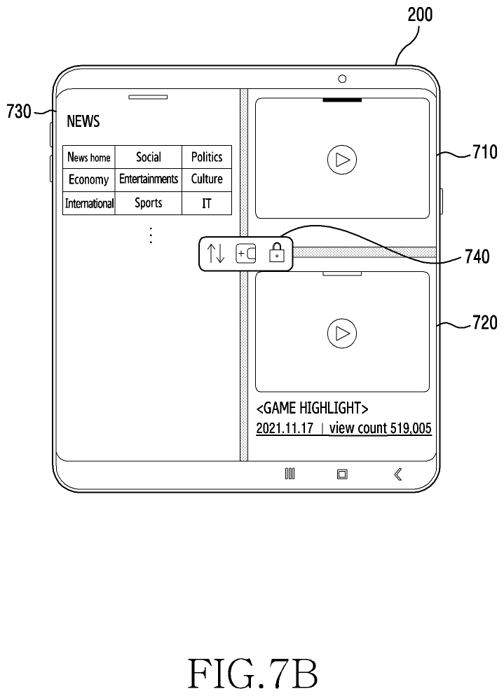

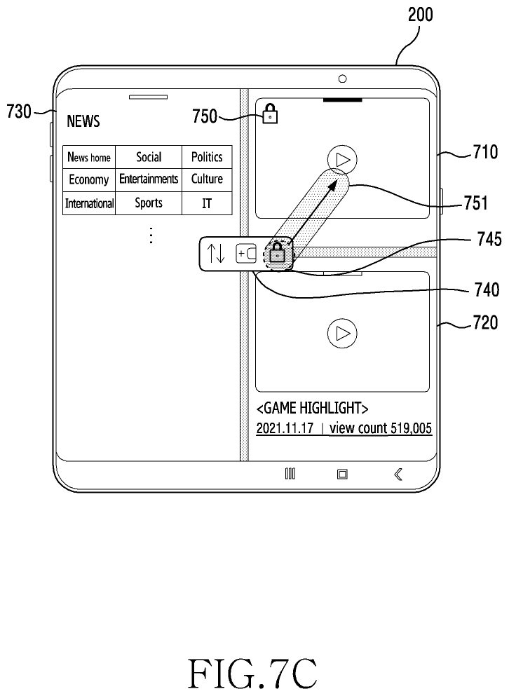

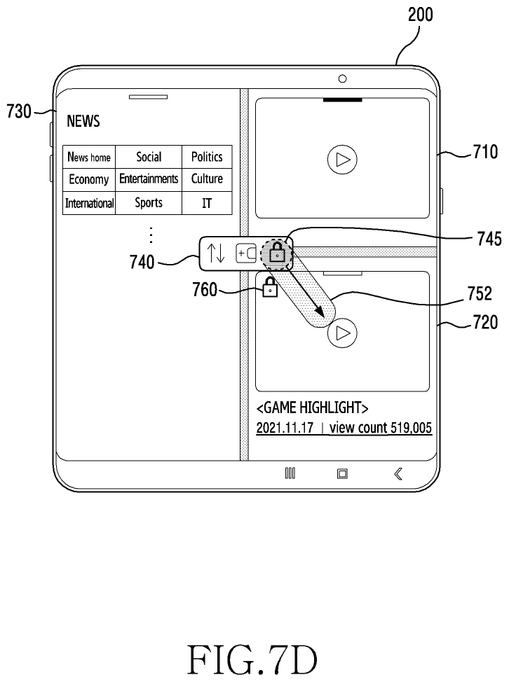

FIGS. 7A, 7B, 7C, and 7D are diagrams explaining a method of lock setting based on a direction of a gesture input when there are two or more windows in which multimedia content is executed on a multi-window screen, according to an embodiment.

Referring to FIG. 7A, while displaying a divided screen including a first window 710, a second window 720, and a third window 730, the electronic device 200 may detect a user input (e.g., a touch input) on one side of the screen. The first window 710, the second window 720, and the third window 730 may correspond to running applications (or programs), and may be displayed in divided regions of the screen, respectively. For example, the first window 710 and the second window 720 may be execution screens of multimedia content (e.g., music, video, game, or streaming service), and the third window 730 may be a web browser execution screen.

In an embodiment, when detecting a touch input on one side of the screen, the electronic device 200 may display a menu item 740 including functions for handling the screen. For example, in FIG. 7B, the electronic device 200 may detect that a touch input is generated in a boundary region between the windows 710, 720, and 730 within the screen, and display the menu item 740 in the boundary region. The electronic device 200 may identify that multimedia content, or content requiring lock setting, is executed in the first window 710 and the second window 720 among windows displayed through the screen, and construct the menu item 740 to include a lock set function 745. The lock set function 745 may be displayed using a user interface element such as an icon or button of a key shape indicating locking. For another example, the electronic device 200 may detect the touch input occurring in a display region of each window displayed through the screen. When detecting the touch input on one side of a display region of the first window 710 or the second window 720 or on an element included in each of these windows 710 and 720 (e.g., an indicator indicating a state corresponding to activation or deactivation of the corresponding window), the electronic device 200 may provide the menu item 740 including the lock set function 745. When detecting the touch input occurring on one side of a display region of the third window 730 or on an element included in the third window 730 (e.g., an indicator indicating the deactivation state of the corresponding window), the electronic device 200 may provide the menu item 740 not including the lock set function 745.

In an embodiment, when detecting a gesture input on the lock set function 745 among the functions displayed through the menu item 740, the electronic device 200 may lock set a window corresponding to a direction of the gesture input. In FIG. 7C, the electronic device 200 may detect a drag input 751 occurring on the lock set function 745, and identify that the drag input 751 is generated in a direction in which the first window 710 is disposed. The electronic device 200 may lock set the first window 710, based on the drag input 751, and display an icon 750 indicating a lock set state on one side (e.g., a corner portion of one side, or an upper or lower central portion) of a display region of the lock set first window 710. Likewise, in FIG. 7D, when detecting a drag input 752 occurring on the lock set function 745, the electronic device 200 may identify that the drag input 752 is generated in a direction in which the second window 720 is disposed, and lock set the second window 720. The electronic device 200 may display an icon 760 indicating a lock set state on one side (e.g., a corner portion of one side, or an upper or lower central portion) of a display region of the lock set second window 720. The electronic device 200 may apply a specified level of brightness or shading to the icons 750 and 760 indicating the lock set state or apply an animation effect such as a sparkling effect to the icons 750 and 760 indicating the lock set state, and display the lock set state. According to various embodiments, the electronic device 200 may display the lock set window in various methods, in addition to the icons 750 and 760 indicating the lock set state. For example, the electronic device 200 may display a text such as ‘lock setting’ or ‘LOCKED’ on one side of the display region (e.g., a corner portion of one side, an upper or lower central portion) of the lock set first window 710 and/or second window 720. For another example, the electronic device 200 may add a border of a specified thickness to a circumferential region of the lock set first window 710 and/or second window 720 and display the border in a specified color, or apply a flickering effect to the border at a specified cycle and display the border. For further example, the electronic device 200 may also apply at least one of a color, pattern or effect indicating a locked state to an element included in the first window 710 and/or the second window 720 (e.g., an indicator indicating a state corresponding to activation or deactivation of the corresponding window) and display the locked state. While the first window 710 and/or the second window 720 are lock set, the electronic device 200 may allow the first window 710 and/or the second window 720 to operate while maintaining the existing setting, and process to provide a service or operation corresponding to a user input or handling command for the non-locked third window 730.

In an embodiment, the electronic device 200 may unlock the first window 710 and/or the second window 720 in the same method as lock setting. For example, when the electronic device 200 detects a user input (e.g., a touch input) on one side of the screen while the first window 710 and/or the second window 720 are locked, the electronic device 200 may display the menu item 740 including the lock set function 745, and detect a drag input on the lock set function 745. The electronic device 200 may unlock a window corresponding to a direction of the drag input among the lock set windows, and remove an indication indicating a lock set state.

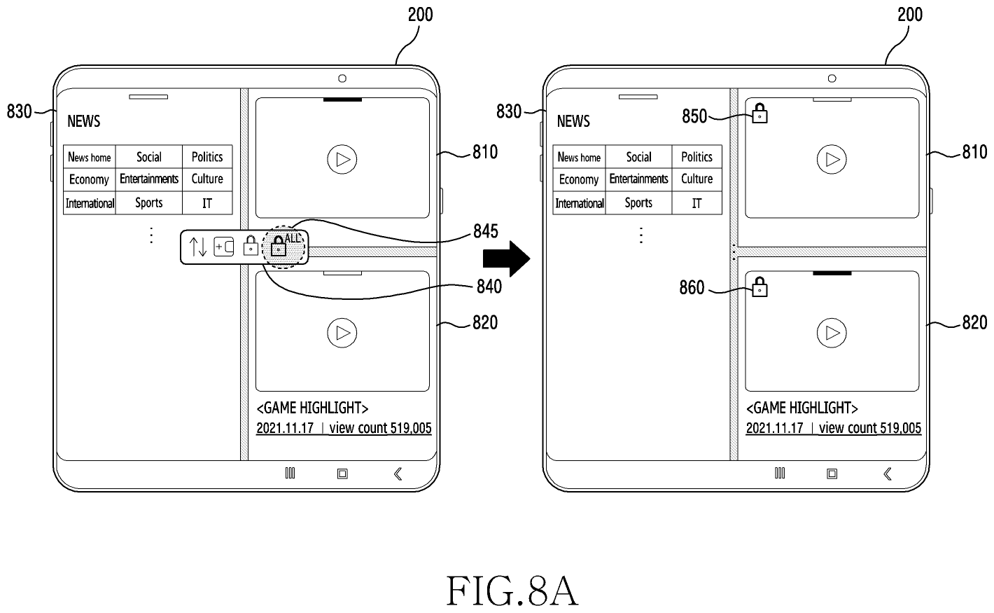

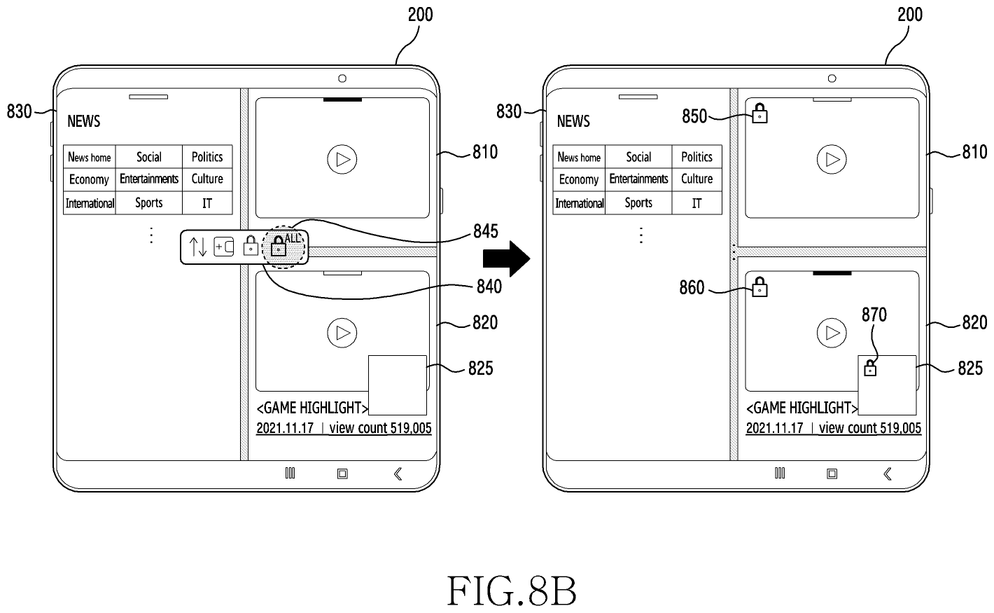

FIGS. 8A and 8B are diagrams explaining a method of simultaneously lock setting when there are two or more windows in which multimedia content is executed on a multi-window screen, according to an embodiment.

Referring to FIG. 8A, while displaying a divided screen including a first window 810, a second window 820 and a third window 830, when detecting a user input (e.g., a touch input) on one side of the screen, the electronic device 200 may display a menu item 840 including functions for handling the screen. In FIG. 8A, the electronic device 200 may identify that multimedia content, or content requiring lock setting, is executed in the first window 810 and the second window 820 among windows displayed through the screen, and construct the menu item 840 to include a simultaneous lock set function 845 capable of locking all of a plurality of windows at once.

In an embodiment, when identifying that the simultaneous lock set function 845 is selected through the menu item 840, the electronic device 200 may set to lock all the first window 810 and the second window 820, and may display an icon 850 or 860 indicating a lock set state on one side (e.g., a corner portion of one side, or an upper or lower central portion) of a display region of the window 810 or 820. According to various embodiments, when the electronic device 200 identifies that the simultaneous lock set function 845 is additionally selected while the plurality of windows are in the lock set state, the electronic device 200 may process to unlock all the plurality of lock set windows. According to various embodiments, in response to the selection of the simultaneous lock set function 845, the electronic device 200 may also analyze the properties of the plurality of windows being executed or the properties of an application related to each window and identify one or more applications belonging to the same or similar category, and process to lock or unlock the one or more identified windows simultaneously.

According to various embodiments, the electronic device 200 may be wirelessly or wiredly connected to a plurality of output devices (e.g., speakers, headsets, televisions, or monitors) and provide a voice and/or image related to a plurality of windows. For example, the electronic device 200 may output an audio signal related to the first window 810 through a first audio device, and output an audio signal related to the second window 820 through a second audio device. In this case, the electronic device 200 may simultaneously lock set the first window 810 and the second window 820 in which multimedia content is being executed, and prevent incorrect audio signals from being output through the first audio device and/or second audio device while two or more multimedia content are being executed.

According to various embodiments, the electronic device 200 may simultaneously lock set even a window that is additionally executed in relation to a window in which multimedia content is executed. Referring to FIG. 8B, the electronic device 200 may detect that link information (e.g., a deep link) provided through the second window 820 is selected while multimedia content, or content requiring lock setting, is being executed in the first window 810 and the second window 820, and additionally display a fourth window 825 corresponding to the link information. The fourth window 825 may include a specific page of an application (or program) executing the second window 820. While the fourth window 825 is executed, the electronic device 200 may overlap the fourth window 825 on one side of the second window 820 and display the overlapped fourth window 825, or divide a screen region in which the second window 820 is displayed and display the second window 820 and the fourth window 825 in the respective divided regions. In an embodiment, when lock setting the second window 820, the electronic device 200 may process to simultaneously lock set the fourth window 825 executed in link to the second window 820. For example, when the electronic device 200 identifies that the simultaneous lock set function 845 is selected through the menu item 840 while the fourth window 825 is displayed, the electronic device 200 may set to lock all the first window 810, the second window 820 and the fourth window 825, and display an icon 850, 860, or 870 indicating a lock set state on one side (e.g., a corner portion of one side, or an upper or lower central portion) of a display region of the window 810, 820, or 825.

According to various embodiments, when the electronic device 200 detect a movement more than a specified level while displaying a multi-window screen including the first window 810, the second window 820 and the third window 830, the electronic device 200 may automatically lock set a window in which multimedia content, or content requiring lock setting, is executed. For example, when a movement amount more than a specified threshold value for the electronic device 200 is detected, even if a touch input on the simultaneous lock set function 845 is not generated, the electronic device 200 may lock set the first window 810 and the second window 820 in which multimedia content, or content requiring a lock setting, is being executed among the plurality of windows 810, 820, and 830, and prevent a change of the size and/or display direction of these windows 810 and 820 during movement.

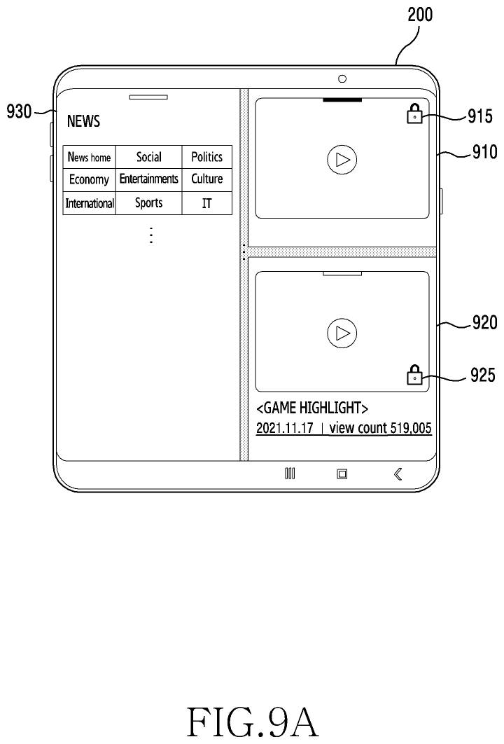

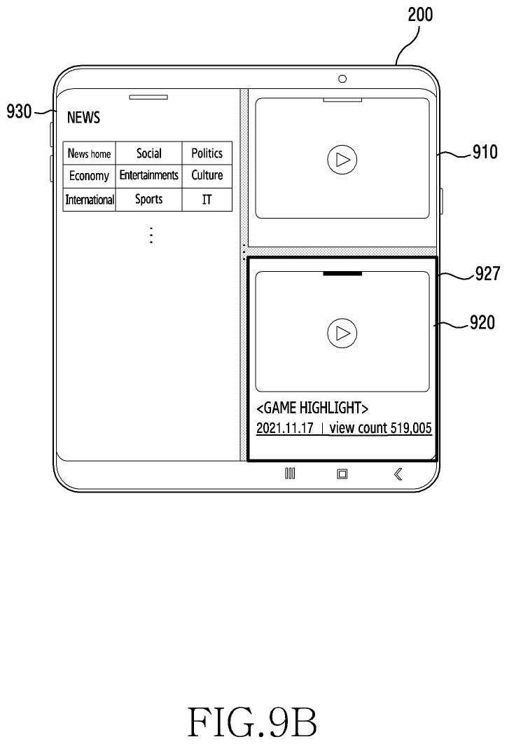

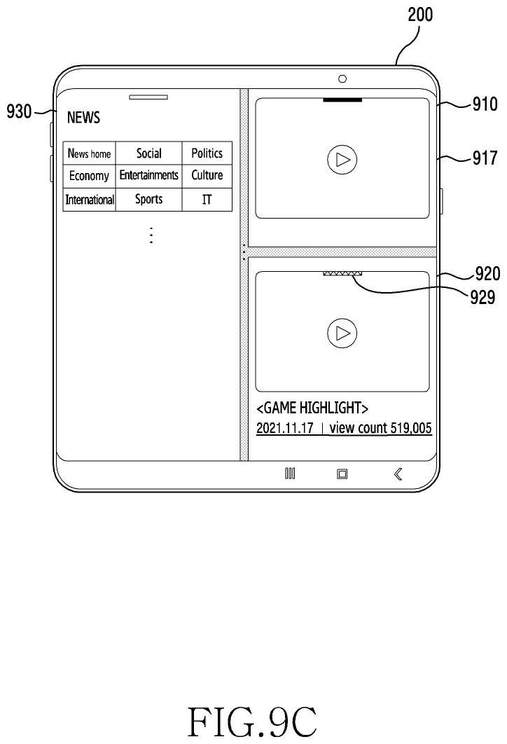

FIGS. 9A, 9B, and 9C are diagrams explaining a method of displaying a lock set window, according to an embodiment. According to various embodiments, while displaying a divided screen including a first window 910, a second window 920, and a third window 930, the electronic device 200 may lock set the first window 910 and/or the second window 920 in which multimedia content, or content requiring lock setting, is executed. The electronic device 200 may display the lock set window by using various methods.

In FIG. 9A, the electronic device 200 may identify that the first window 910 and the second window 920 are lock set, and display an icon 915 or 925 indicating a lock set state on one side of a display region of each window. The electronic device 200 may display the icon 915 or 925 on a corner of one side of each window so as not to obstruct a user's view while the first window 910 and/or the second window 920 are lock set. Positions where the icons 915 and 925 indicating the lock set state are displayed may be changed by user setting. The electronic device 200 may apply a specified level of brightness or shading to the icons 915 and 925, or apply an animation effect such as a sparkling effect to the icons 915 and 925 and display the lock set state. According to various embodiments, the electronic device 200 may also display a text such as ‘lock setting’ or ‘LOCKED’, instead of the icons 915 and 925 or together with the icons 915 and 925.

In FIG. 9B, the electronic device 200 may identify that the second window 920 among windows included in the screen is lock set, and display a border 927 of a specified thickness in a circumferential region of the second window 920. For example, while the second window 920 is lock set, the electronic device 200 may display the border 927 in a color specified corresponding to a locked state. For another example, while the second window 920 is lock set, the electronic device 200 may also apply an animation effect such as a flickering effect to the border 927 and display a lock set state.

In FIG. 9C, the electronic device 200 may identify that the second window 920 among the windows included in the screen is lock set, and display a lock set state by using an indicator 929 included in the second window 920. The electronic device 200 may display the indicator 929 to be distinguished from a window that is in an activation state or deactivation state. For example, while the second window 920 is lock set, the electronic device 200 may apply at least one of a color, pattern, or effect specified corresponding to a locked state, to the indicator 929, and display the locked state.

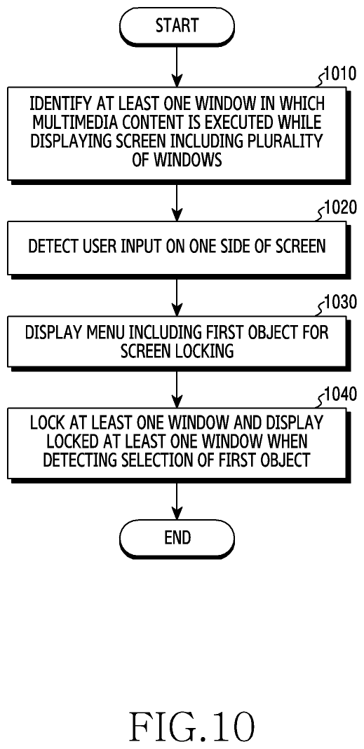

FIG. 10 is a flowchart illustrating a method of operating an electronic device, according to an embodiment. According to an embodiment, the electronic device 200 is a device providing a lock set function for a screen on which multimedia content is being executed in a multi-window environment, and may correspond to the electronic device 101 shown in FIG. 1 or the electronic device 200 shown in FIG. 2. The operations of FIG. 10 may be performed by at least one processor (e.g., the processor 120 of FIG. 1 or the at least one processor 220 of FIG. 2) included in the electronic device 200.

Referring to FIG. 10, in operation 1010, the electronic device 200 may identify at least one window in which multimedia content is executed while displaying a divided screen including a plurality of windows on a display (e.g., the display module 160 of FIG. 1 or the display 210 of FIG. 2). For example, the multimedia content may include at least one of music, video, game, or streaming service. In operation 1010, when a program or data loaded at the time of providing multimedia content is detected, the electronic device 200 may identify that the multimedia content is executed.

According to an embodiment, in operation 1020, while displaying the divided screen, the electronic device 200 may detect a user input on at least one side of the screen. For example, the electronic device 200 may detect a user's touch input through a boundary region between the plurality of windows displayed within the divided screen or a display region of the at least one window in which the multimedia content is executed within the screen.

According to an embodiment, in operation 1030, in response to the user input, the electronic device 200 may display a menu item for screen handling. The menu item may include a first object for lock setting the at least one window. According to various embodiments, the first object may be provided using a user interface element such as an icon or button indicating a locking function.

According to an embodiment, in operation 1040, the electronic device 200 may detect a selection of the first object, and lock the at least one window and display the locked at least one window. The electronic device 200 may identify the selection of the first object, based on a gesture input (e.g., a touch input or drag input) occurring on the first object. While the at least one window is lock set, the electronic device 200 may allow the at least one window to operate while maintaining the existing setting, and may process not to perform a detected user input or handling command for the at least one window. While the at least one window is lock set, the electronic device 200 may process to provide a service or operation corresponding to a user input or handling command for the remaining windows excluding the at least one window.

According to various embodiments, in operation 1040, the electronic device 200 may lock two or more windows in which multimedia content is executed among the plurality of windows displayed on the screen. For example, the electronic device 200 may lock set all the two or more windows while sequentially activating the two or more windows. The electronic device 200 may identify that a window corresponding to a region most recently touched by a user is in an activation state. In this case, when the electronic device 200 identifies a selection of the first object based on a touch input while a first window is in the activation state, the electronic device 200 may lock set the first window. Thereafter, the electronic device 200 may identify that a second window, which is different from the first window, is converted to the activation state, and display the menu item, based on a user input detected within the screen. When the electronic device 200 identifies that the first object is selected through the menu item while the second window is in the activation state, the electronic device 200 may set to additionally lock the second window.

For another example, the electronic device 200 may lock the two or more windows, based on a direction of a drag input detected on the first object. When detecting that the drag input is generated toward a region where the first window is disposed, the electronic device 200 may lock set the first window. Thereafter, when detecting a drag input toward a region where the second window is disposed while the first window is in a locked state, the electronic device 200 may set to additionally lock the second window.

For further example, the electronic device 200 may provide a function capable of simultaneously locking the two or more windows. When identifying the two or more windows in which the multimedia content is executed while providing the plurality of windows through the screen, the electronic device 200 may additionally provide a second object for simultaneous lock setting through the menu item, in response to a user input detected on at least one side of the screen. When detecting a gesture input on the second object, the electronic device 200 may set to lock all the two or more windows.

In operation 1040, the electronic device 200 may display locked at least one window in various methods. For example, the electronic device 200 may display an icon indicating a locked state on one side of the locked at least one window. The electronic device 200 may apply a specified level of brightness or shading to the icon and display the locked state, or apply an animation effect to the icon and display the locked state. For another example, the electronic device 200 may display a border of a specified thickness in at least a circumferential region of the locked window. The electronic device 200 may display the border in a specified color, or apply a flickering effect to the border at a specified cycle and display a lock set state. For further example, the electronic device 200 may display the locked state by using an indicator included in the at least one window. The indicator may be a user interface that displays a state corresponding to activation or deactivation of each window. The electronic device 200 may apply at least one of a color, pattern, or effect corresponding to the locked state, to the indicator, and display the locked state.

According to various embodiments, after operation 1040, when detecting a selection of the first object while the at least one window is lock set, the electronic device 200 may unlock the at least one lock set window. For example, when detecting a user input on at least one side of the screen while the first window is lock set, the electronic device 200 may provide a menu item including the first object, and when the first object is selected through the menu item, the electronic device 200 may unlock the first window that is in a lock set state. For another example, when two or more windows are lock set, the electronic device 200 may unlock the two or more windows by using the first object while sequentially activating the two or more windows, or may unlock the two or more windows, based on a direction of a gesture input on the first object. According to various embodiments, the electronic device 200 may additionally provide a second object through the menu item, and when detecting a gesture input on the second object while the two or more windows are in a lock set state, the electronic device 200 may unlock all the two or more windows simultaneously.

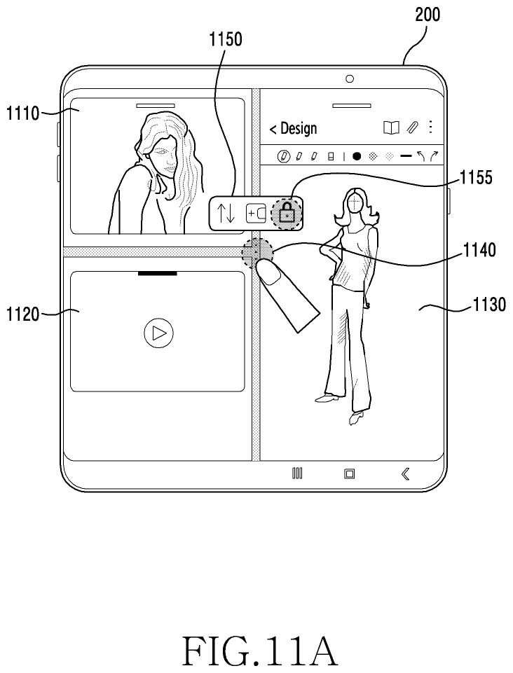

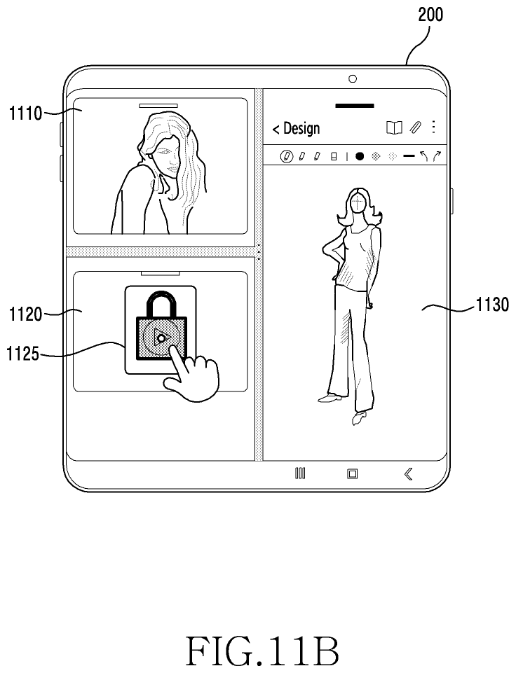

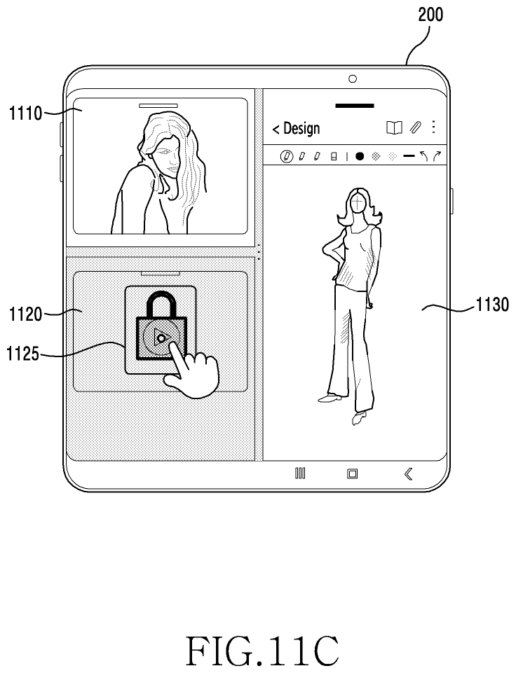

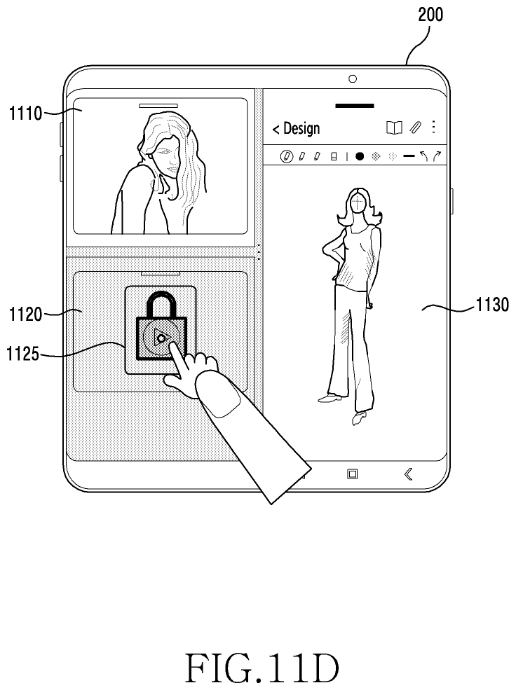

FIGS. 11A, 11B, 11C, and 11D are diagrams explaining a method of locking and unlocking a window in which multimedia content is executed on a multi-window screen, according to an embodiment.

Referring to FIG. 11A, while displaying a divided screen including a first window 1110, a second window 1120, and a third window 1130, the electronic device 200 may detect a user's touch input on one side of the screen. The first window 1110, the second window 1120, and the third window 1130 may correspond to running applications (or programs), and may be displayed in divided regions of the screen, respectively. For example, the second window 1120 among a plurality of windows displayed through the screen may be a multimedia content execution screen (e.g., music, video, game, or streaming service).

In an embodiment, when detecting that a user's touch input is generated in a boundary region 140 between the windows 1110, 1120, and 1130 within the screen, the electronic device 200 may display a menu item 1150 around the boundary region 1140. The electronic device 200 may identify that multimedia content, or content requiring lock setting, is executed in the second window 1120 among the windows displayed through the screen, and construct the menu item 1150 to include a lock set function 1155. The lock set function 1155 may be displayed using a user interface element such as an icon or button of a key shape indicating locking.

In an embodiment, the electronic device 200 may identify that the lock set function 1155 is selected, based on a gesture input detected on the lock set function 1155 among functions displayed through the menu item 1150. In response to the selection of the lock set function 1155, the electronic device 200 may lock set the second window 1120. For example, as shown in FIG. 11B, the electronic device 200 may display an icon 1125 indicating a lock set state in a display region of the second window 1120. For another example, as shown in FIG. 11C, the electronic device 200 may also shade and display the display region, in addition to displaying the icon 1125 indicating the lock set state in the display region of the second window 1120.

According to various embodiments, after lock setting the second window 1120, the electronic device 200 may change the activation state of the windows 1110, 1120, and 1130. When the second window 1120 is lock set in the activation state, the electronic device 200 may also display the non-locked first window 1110 or third window 1130 in the activation state, instead of changing the second window 1120 to a deactivation state. For example, the electronic device 200 may change the window having the most recent activation history among the non-locked windows 1110 and 1130 to the activation state.

In an embodiment, the electronic device 200 may unlock the second window 1120 in a method different from the lock setting. Referring to FIG. 11D, when detecting a touch input on the icon 1125 while displaying the icon 1125 indicating the lock set state in the display region of the lock set second window 1120, the electronic device 200 may unlock the second window 1120 and remove an indication indicating the lock set state.

According to various embodiments, the electronic device 200 may also unlock the second window 1120 in the same method as the lock setting. When the electronic device 200 detects a touch input in the boundary region 1140 of the screen while the second window 200 is lock set, the electronic device 200 may display the menu item 1150 including the lock set function 1155 or a lock release function. In response to the selection of the lock set function 1155 or the lock release function, the electronic device 200 may unlock the lock set second window 1120, and remove an indication indicating the lock set state.

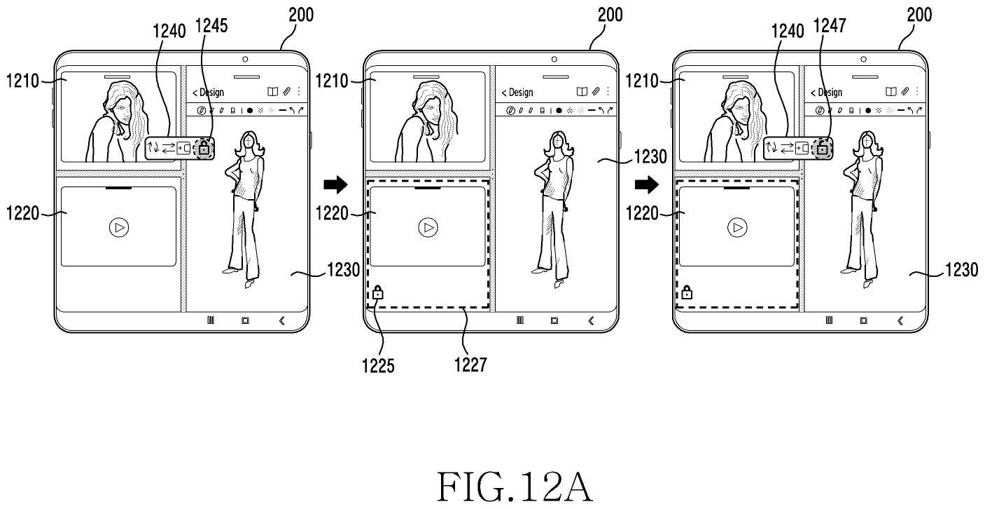

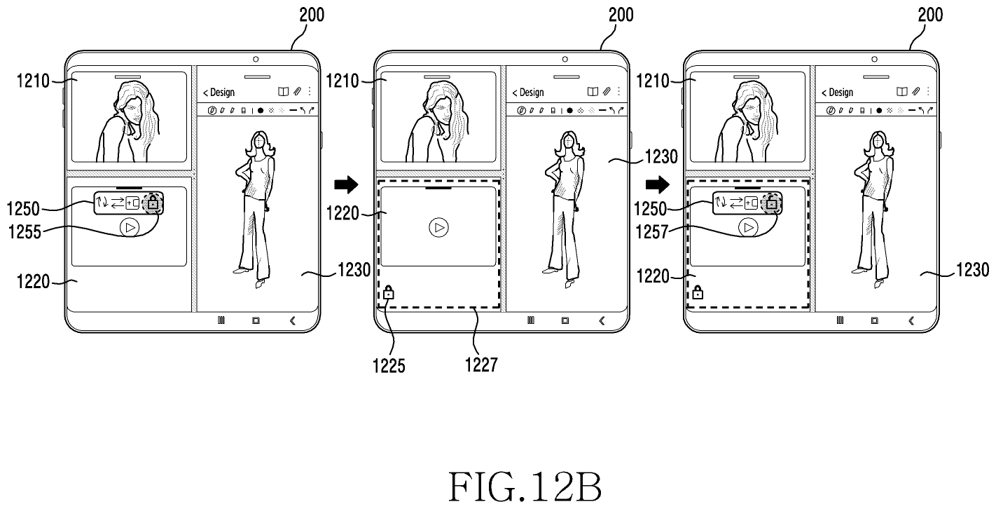

FIGS. 12A and 12B are diagrams explaining a method of locking and unlocking a window in which multimedia content is executed through a menu item on a multi-window screen, according to an embodiment.

Referring to FIG. 12A, while displaying a divided screen including a first window 1210, a second window 1220 and a third window 1230, when detecting a user's touch input in a boundary region between the windows 1210, 1220 and 1230 within the screen, the electronic device 200 may display a menu item 1240 including functions for handling the screen around the boundary region. The electronic device 200 may identify that multimedia content, or content requiring lock setting, is executed in the second window 1220 among the windows displayed through the screen, and construct the menu item 1240 to include a lock set function 1245.

In an embodiment, when identifying that the lock set function 1245 is selected among the functions displayed through the menu item 1240, the electronic device 200 may lock set the second window 1220. The electronic device 200 may display an icon 1225 indicating a lock set state on one side (e.g., a lower corner portion) of a display region of the lock set second window 1220. According to various embodiments, the electronic device 200 may display the lock set state in a method of adding a border 1227 to a circumferential region of the second window 1220, in addition to the icon 1225 indicating the lock set state. For example, the electronic device 200 may display the border in a specified color or pattern or at a specified thickness. For another example, the electronic device 200 may apply a flickering effect to the border at a specified cycle and display the border. In an embodiment, the electronic device 200 may detect a user's touch input in the boundary region between the windows 1210, 1220 and 1230 within the screen while the second window 1220 is lock set. In response to the touch input, the electronic device 200 may display the menu item 1240 around the boundary region. At this time, the electronic device 200 may identify that the second window 1220 is in a lock set state, and construct the menu item 1240 to include a lock release function 1247. When identifying that the lock release function 1247 is selected among the functions displayed through the menu item 1240, the electronic device 200 may unlock the second window 1220, and remove the icon 1225 and the border 1227 indicating the lock set state.

Referring to FIG. 12B, while displaying a divided screen including a first window 1210, a second window 1220, and a third window 1230, the electronic device 200 may detect a user's touch input on the second window 1220. The electronic device 200 may identify that multimedia content, or content requiring lock setting, is executed in the second window 1220 where the touch input is detected, and display a menu item 1250 including a lock set function 1255 in a display region of the second window 1220. The electronic device 200 may display the menu item 1250 around a point where the touch input is detected in the second window 1220.

In an embodiment, when identifying that the lock set function 1255 is selected among functions displayed through the menu item 1250, the electronic device 200 may lock set the second window 1220. The electronic device 200 may display an icon 1225 indicating a lock set state on one side (e.g., a lower corner portion) of a display region of the lock set second window 1220. According to various embodiments, the electronic device 200 may display the lock set state in a method of adding a border 1227 to a circumferential region of the second window 1220, in addition to the icon 1225 indicating the lock set state. For example, the electronic device 200 may display the border in a specified color or pattern or at a specified thickness. For another example, the electronic device 200 may apply a flickering effect to the border at a specified cycle and display the border. In an embodiment, the electronic device 200 may detect a user's touch input on the second window 1220 while the second window 1220 is lock set. In response to the touch input, the electronic device 200 may display the menu item 1250 around a point where the touch input is detected. At this time, the electronic device 200 may identify that the second window 1220 is in the lock set state, and construct the menu item 1250 to include a lock release function 1257. When identifying that the lock release function 1257 is selected among the functions displayed through the menu item 1250, the electronic device 200 may unlock the second window 1220, and remove the icon 1225 and the border 1227 indicating the lock set state.

An electronic device (e.g., the electronic device 200) of an embodiment may include a display (e.g., the display 210), a memory (e.g., the memory 230) configured to store executable instructions, and at least one processor (e.g., the processor 220) operatively connected with the display, and configured to access the memory and execute the instructions. The at least one processor may be configured to, while displaying a divided screen including a plurality of windows on the display, identify at least one window in which multimedia content is executed, display a menu item including a first object for lock setting, in response to receiving a first user input on one side of the screen, and when receiving a second user input for the first object, lock the at least one window and display the locked at least one window.

In an embodiment, the at least one processor may be configured to identify that a first window among the at least one window is in an activation state, and lock set the first window in response to identifying a selection of the first object based on the second user input.

In an embodiment, the at least one processor may be configured to identify that a second window, which is different from the first window, among the at least one window, is converted to the activation state, display the menu item including the first object when receiving the first user input on at least one side of the screen, and lock set the second window in response to identifying the selection of the first object.

In an embodiment, the at least one processor may be configured to identify a direction of the second user input received with respect to the first object, and lock a window corresponding to the direction of the second user input among the at least one window.

In an embodiment, the at least one processor may be configured to, when identifying two or more windows in which multimedia content is executed among the plurality of windows, display a second object for simultaneous lock setting within the menu item, in response to the first user input detected on at least one side of the screen, and when receiving a third user input for the second object, lock all the two or more windows.

In an embodiment, the at least one processor may be configured to display the menu item when receiving the first user input in at least one of a boundary region between the plurality of windows or a display region of each of the at least one window.

In an embodiment, the at least one processor may be configured to display an icon indicating a locked state on one side of the locked at least one window.

In an embodiment, the at least one processor may be configured to display a border of a specified thickness in a circumferential region of the locked at least one window.

In an embodiment, the at least one processor may be configured to display an indicator indicating an activation state or deactivation state of each window on each of the plurality of windows, and apply at least one of a color, pattern, or effect corresponding to the locked state, to an indicator included in the locked at least one window, and display the locked state.

In an embodiment, the at least one processor may be configured to, when receiving the first user input on at least one side of the screen while the at least one window is lock set, display the menu item including the first object, and in response to identifying a selection of the first object, unlock the at least one window.

A method of operating an electronic device (e.g., the electronic device 200) of an embodiment may include, while displaying a divided screen including a plurality of windows on a display (e.g., the display 210), identifying at least one window in which multimedia content is executed, displaying a menu item including a first object for lock setting, in response to receiving a first user input on at least one side of the screen, and when receiving a second user input for the first object, locking the at least one window and displaying the locked at least one window.

In an embodiment, the locking of the at least one window may include identifying that a first window among the at least one window is in an activation state, and lock setting the first window, in response to identifying a selection of the first object based on the second user input.

In an embodiment, the locking of the at least one window may include identifying that a second window, which is different from the first window, among the at least one window, is converted to the activation state, displaying the menu item including the first object when receiving the first user input on at least one side of the screen, and lock setting the second window, in response to identifying the selection of the first object.

In an embodiment, the locking of the at least one window may include identifying a direction of the second user input received with respect to the first object, and locking a window corresponding to the direction of the second user input among the at least one window.

In an embodiment, the locking of the at least one window may include identifying two or more windows in which multimedia content is executed among the plurality of windows, displaying a second object for simultaneous lock setting within the menu item, in response to the first user input detected on at least one side of the screen, and locking all the two or more windows when receiving a third user input for the second object.

In an embodiment, the displaying of the menu item may include displaying the menu item when receiving the first user input in at least one of a boundary region between the plurality of windows or a display region of each of the at least one window.

In an embodiment, the locking and displaying of the at least one window may include displaying an icon indicating a locked state on one side of the locked at least one window.

In an embodiment, the locking and displaying of the at least one window may include displaying a border of a specified thickness in a circumferential region of the locked at least one window.

In an embodiment, the locking and displaying of the at least one window may include applying at least one of a color, pattern, or effect corresponding to the locked state, to an indicator included in the locked at least one window, and displaying the locked state.

In an embodiment, the method may further comprises displaying the menu item comprising the first object when receiving the first user input on at least one side of the screen while the at least one window is lock set, and unlocking the at least one window in response to identifying a selection of the first object.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
at least one processor; and
memory storing instructions that, when executed by the at least one processor, cause the electronic device to:
while displaying a divided screen comprising a plurality of windows on the display, identify at least one window in which multimedia content is executed;
display a menu item comprising a first object for lock setting, in response to receiving a first user input on one side of the divided screen; and
when receiving a second user input for the first object, lock the at least one window and display the at least one window that is locked.

2. The electronic device of claim 1, wherein the instructions, when executed by the at least one processor, cause the electronic device to:
identify that a first window among the at least one window is in an activation state; and
lock set the first window in response to identifying a selection of the first object based on the second user input.

3. The electronic device of claim 2, wherein the instructions, when executed by the at least one processor, cause the electronic device to:
identify that a second window, which is different from the first window, among the at least one window, is converted to the activation state,
when receiving the first user input on at least one side of the divided screen, display the menu item comprising the first object; and
lock set the second window in response to identifying the selection of the first object.

4. The electronic device of claim 1, wherein the instructions, when executed by the at least one processor, cause the electronic device to:
identify a direction of the second user input received with respect to the first object; and
lock a window corresponding to the direction of the second user input among the at least one window.

5. The electronic device of claim 1, wherein the instructions, when executed by the at least one processor, cause the electronic device to:
when identifying two or more windows in which multimedia content is executed among the plurality of windows, display a second object for simultaneous lock setting within the menu item, in response to the first user input detected on at least one side of the divided screen; and
when receiving a third user input for the second object, lock all the two or more windows.

6. The electronic device of claim 1, wherein the instructions, when executed by the at least one processor, cause the electronic device to
display the menu item when receiving the first user input in at least one of a boundary region between the plurality of windows or a display region of each of the at least one window.

7. The electronic device of claim 1, wherein the instructions, when executed by the at least one processor, cause the electronic device to
display an icon indicating a locked state on one side of the at least one window that is locked, or display a border of a specified thickness in a circumferential region of the at least one window that is locked.

8. The electronic device of claim 1, wherein the instructions, when executed by the at least one processor, cause the electronic device to:
display an indicator indicating an activation state or deactivation state of each window on each of the plurality of windows; and
apply at least one of a color, pattern, or effect corresponding to a locked state, to another indicator comprised in the at least one window that is locked, and display the locked state.

9. The electronic device of claim 1, wherein the instructions, when executed by the at least one processor, cause the electronic device to:
when receiving the first user input on at least one side of the divided screen while the at least one window is lock set, display the menu item comprising the first object; and
in response to identifying a selection of the first object, unlock the at least one window.

10. A method of operating an electronic device, the method comprising:
while displaying a divided screen comprising a plurality of windows on a display, identifying at least one window in which multimedia content is executed;
displaying a menu item comprising a first object for lock setting, in response to receiving a first user input on at least one side of the divided screen; and
when receiving a second user input for the first object, locking the at least one window and displaying the at least one window that is locked.

11. The method of claim 10, wherein the locking of the at least one window comprises:
identifying that a first window among the at least one window is in an activation state;
lock setting the first window, in response to identifying a selection of the first object based on the second user input;
identifying that a second window, which is different from the first window, among the at least one window, is converted to the activation state;
when receiving the first user input on at least one side of the divided screen, displaying the menu item comprising the first object; and
lock setting the second window, in response to identifying the selection of the first object.

12. The method of claim 10, wherein the locking of the at least one window comprises:
identifying a direction of the second user input received with respect to the first object; and
locking a window corresponding to the direction of the second user input among the at least one window.

13. The method of claim 10, wherein the locking of the at least one window comprises:
identifying two or more windows in which multimedia content is executed among the plurality of windows;
displaying a second object for simultaneous lock setting within the menu item, in response to the first user input detected on at least one side of the divided screen; and
locking all the two or more windows when receiving a third user input for the second object.

14. The method of claim 10, wherein the locking and displaying of the at least one window comprises:
displaying an icon indicating a locked state on one side of the at least one window that is locked; and/or
displaying a border of a specified thickness in a circumferential region of the at least one window that is locked.

15. The method of claim 10, wherein the locking and displaying of the at least one window comprises
applying at least one of a color, pattern, or effect corresponding to a locked state, to an indicator comprised in the at least one window that is locked, and displaying the locked state.
